(19) United States
(12) Patent Application Publication
(10) Pub. No.: US 2016/0325365 A1
(43) Pub. Date: Nov. 10, 2016

(54) Enclosed Water Saw Assembly

(71) Applicant: Jeremy Jones, Yuba City, CA (US)

(72) Inventor: Jeremy Jones, Yuba City, CA (US)

(21) Appl. No.: 14/707,275

(22) Filed: May 8, 2015

(51) Int. Cl. B23D 59/02; B28D 7/02; B28D 1/02; B23D 47/02

(52) U.S. Cl. CPC B23D 59/025; B23D 47/025; B28D 7/02; B28D 1/02

(57) ABSTRACT

An enclosed water saw assembly includes an enclosure that has a bottom wall and the bottom wall is structured to define a well extending downwardly therefrom. The bottom wall slopes downwardly toward the well to direct a fluid into the well. A first support is coupled to the enclosure and a second support is slidably attached to the enclosure. Each of the first support and the second support may have a water saw positioned thereon. A pump is positioned within the well and the pump may be fluidly coupled to the water saw. The pump urges the fluid in the well into the water saw such that the pump re-circulates overspray from the water saw. A tent is removably positioned on the enclosure to contain overspray from the water saw within the enclosure. A cover is positionable on the enclosure.

### BACKGROUND OF THE DISCLOSURE

### Field of the Disclosure

The disclosure relates to water saw devices and more particularly pertains to a new water saw device for providing a portable work space to contain overspray from the water saw.

### SUMMARY OF THE DISCLOSURE

An embodiment of the disclosure meets the needs presented above by generally comprising an enclosure that has a bottom wall and the bottom wall is structured to define a well extending downwardly therefrom. The bottom wall slopes downwardly toward the well to direct a fluid into the well. A first support is coupled to the enclosure and a second support is slidably attached to the enclosure. Each of the first support and the second support may have a water saw positioned thereon. A pump is positioned within the well and the pump may be fluidly coupled to the water saw. The pump urges the fluid in the well into the water saw such that the pump re-circulates overspray from the water saw. A tent is removably positioned on the enclosure to contain overspray from the water saw within the enclosure. A cover is positionable on the enclosure.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of an enclosed water saw assembly according to an embodiment of the disclosure.

FIG. 2 is a top view of an embodiment of the disclosure.

FIG. 3 is a cross sectional view taken along line 3-3 of FIG. 2 of an embodiment of the disclosure.

FIG. 4 is a perspective view of an embodiment of the disclosure.

FIG. 5 is a perspective in-use view of an embodiment of the disclosure.

FIG. 6 is a perspective phantom view of an embodiment of the disclosure in a retracted position.

FIG. 7 is a perspective phantom view of an embodiment of the disclosure in an extended position.

### DESCRIPTION OF THE PREFERRED EMBODIMENT

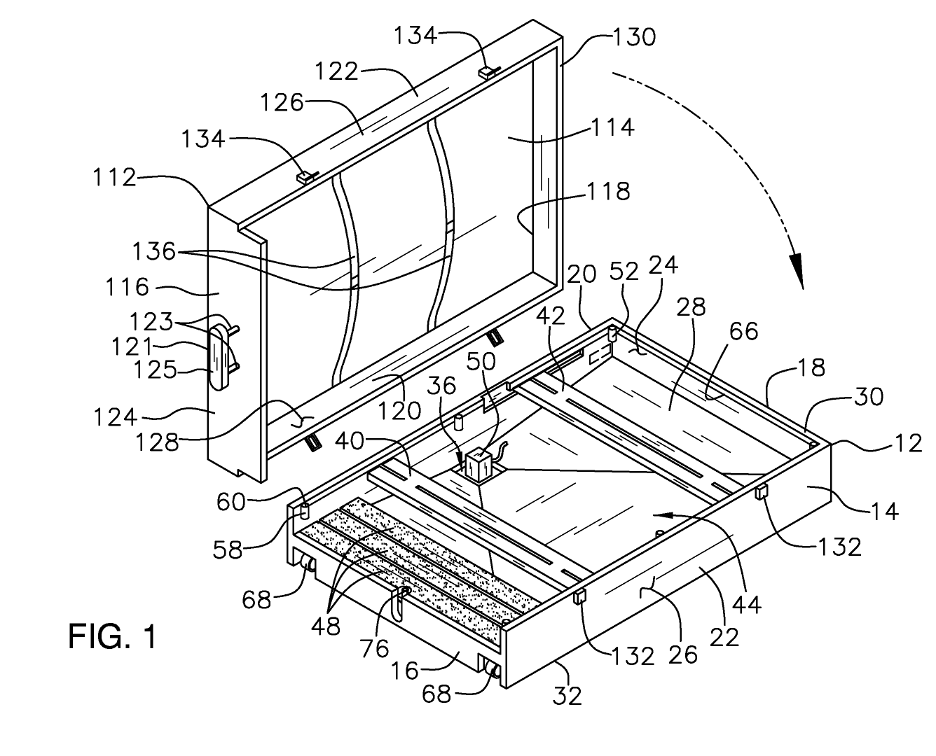

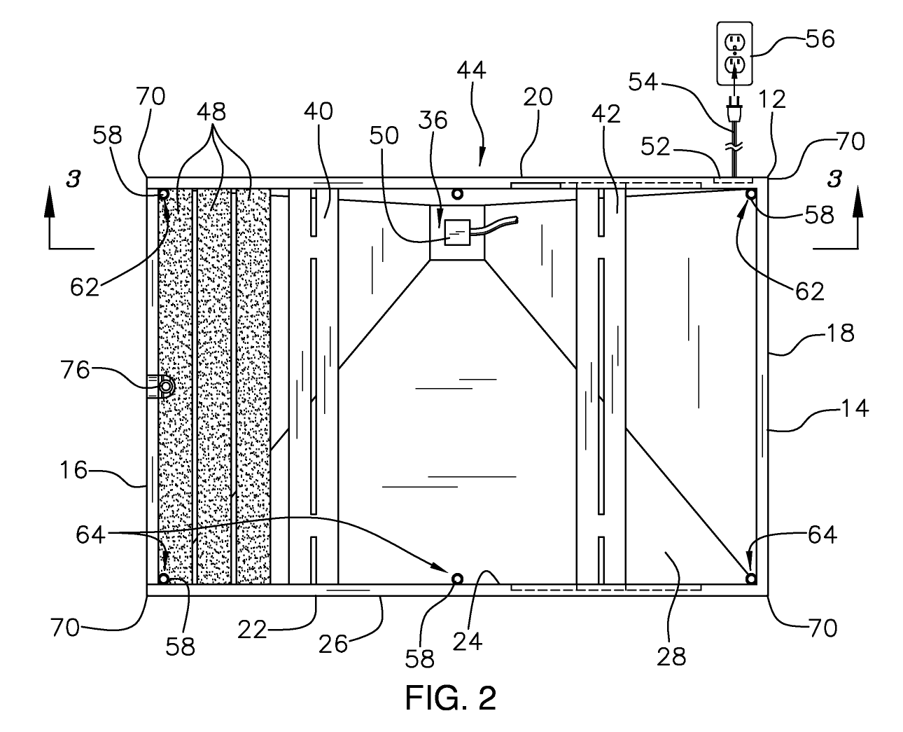

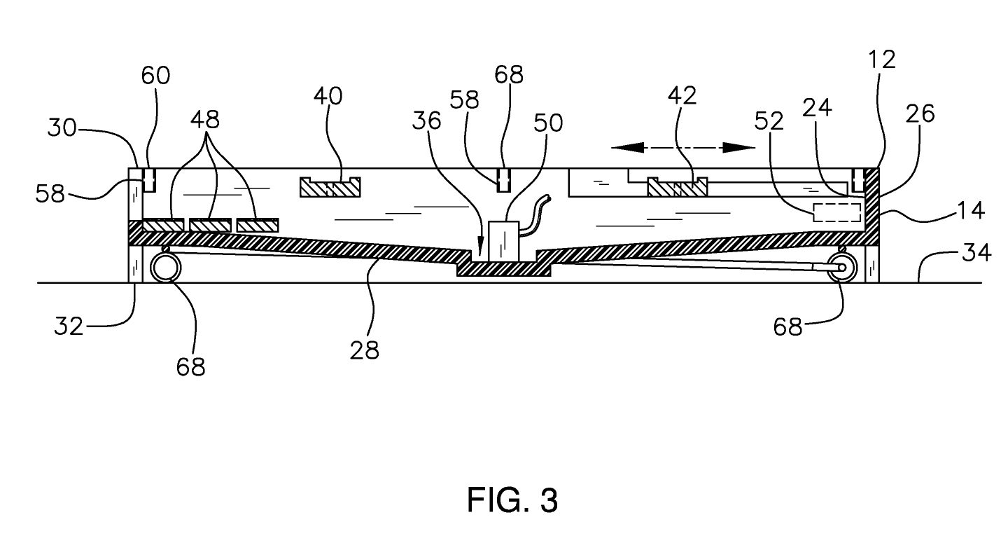

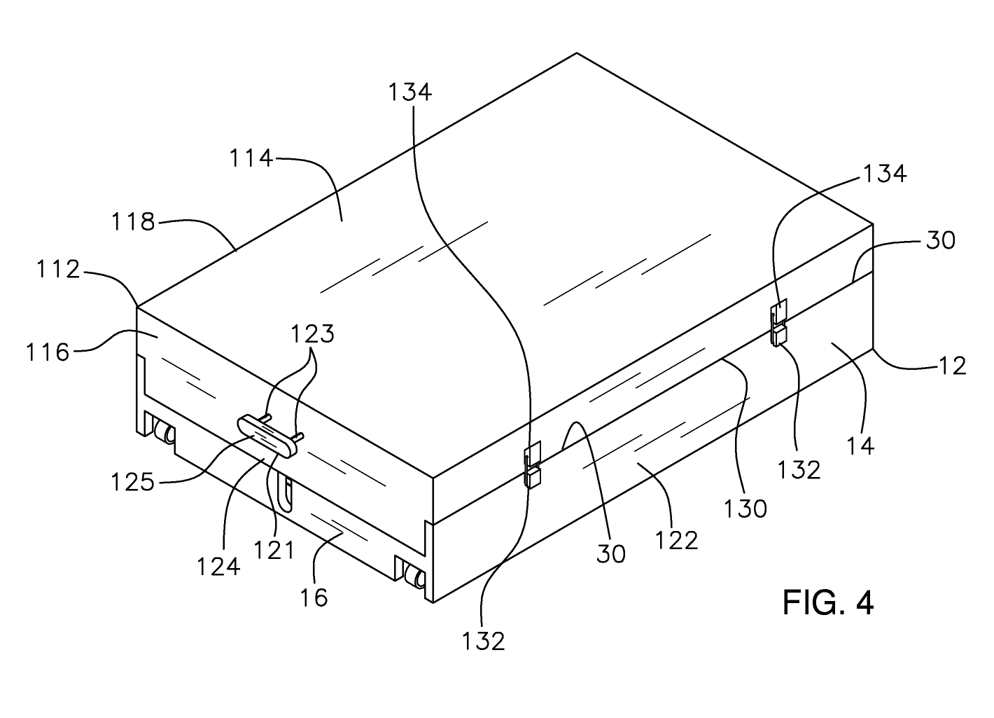

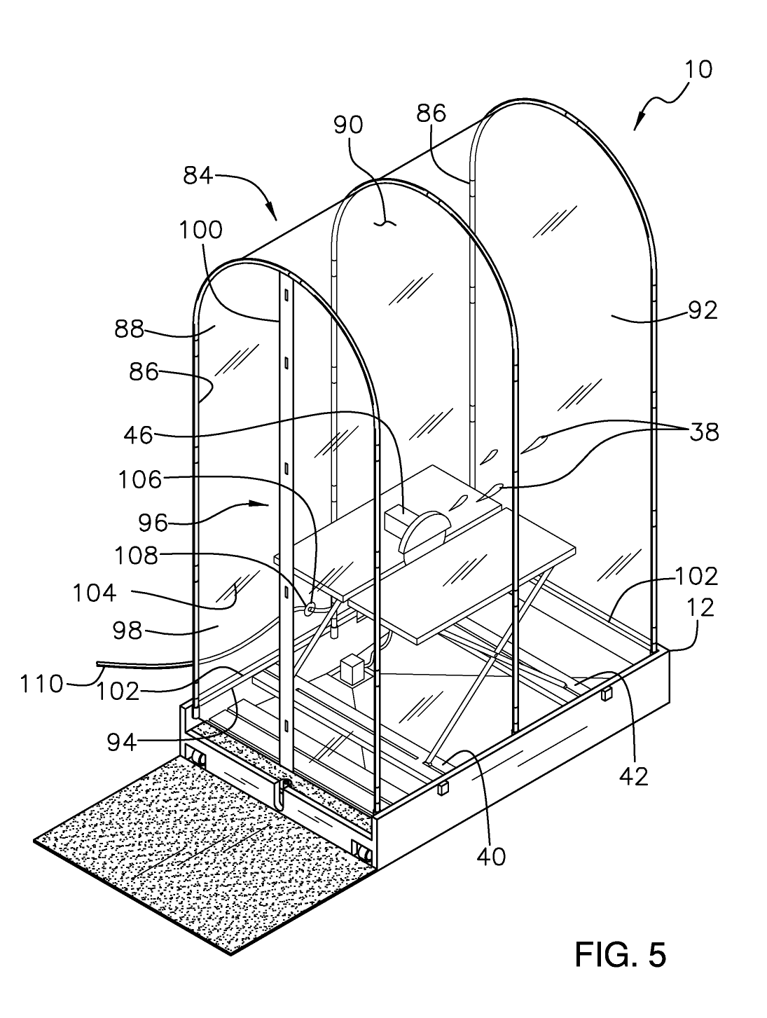

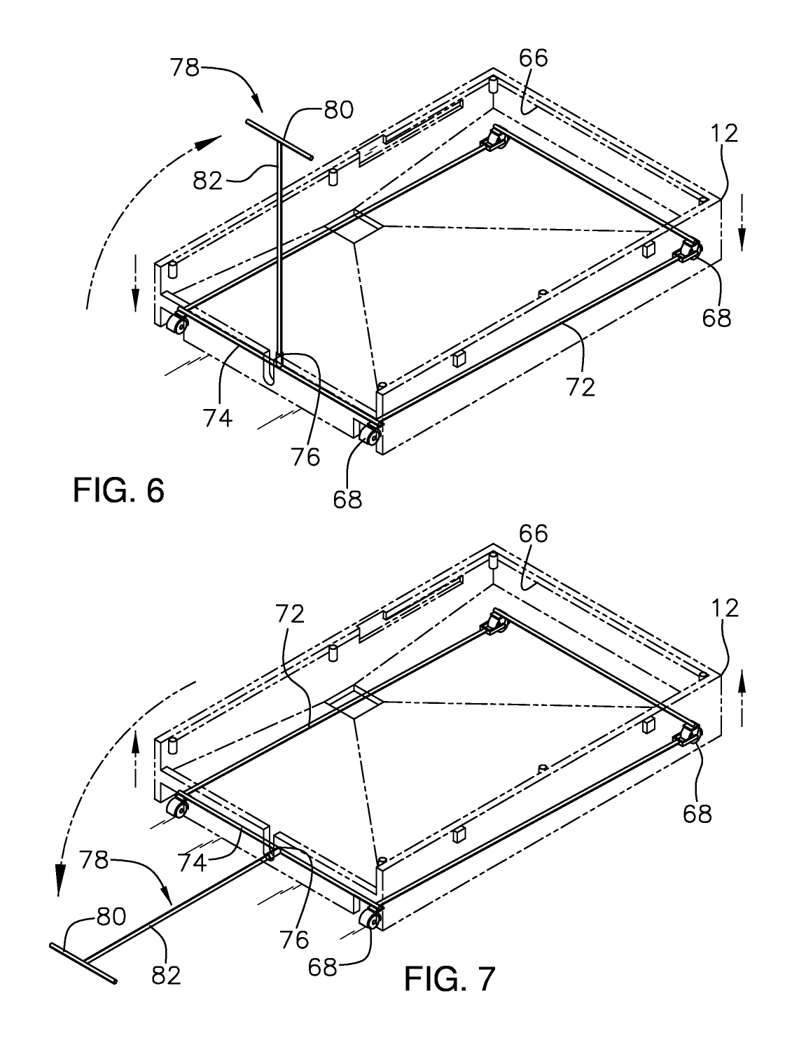

With reference now to the drawings, and in particular to FIGS. 1 through 7 thereof, a new water saw device embodying the principles and concepts of an embodiment of the disclosure and generally designated by the reference numeral 10 will be described.

As best illustrated in FIGS. 1 through 7, the enclosed water saw assembly 10 generally comprises an enclosure 12 that has a peripheral wall 14 and the peripheral wall 14 has a front side 16, a back side 18, a first lateral side 20 and a second lateral side 22. The peripheral wall 14 has an inner surface 24 and an outer surface 26 and the enclosure 12 includes a bottom wall 28 coupled to the inner surface 24. The bottom wall 28 extends between the front side 16, the back side 18, the first lateral side 20 and the second lateral side 22. The peripheral wall 14 has a top edge 30 and a bottom edge 32 and the bottom wall 28 is positioned between the top edge 30 and the bottom edge 32. The bottom edge 32 may be positioned on a support surface 34 and the support surface 34 may be ground or a floor.

The bottom wall 28 is structured to define a well 36 extending downwardly therefrom. The well 36 is positioned adjacent to the first lateral side 20 and the well 36 is centrally positioned on the first lateral side 20. The bottom wall 28 slopes downwardly from the front side 16, the back side 18 and second lateral side 22 toward the well 36 to direct a fluid 38 into the well 36. The fluid 38 may be water. The front side 16 has a height that is less than a height of each of the back side 18, the first lateral side 20 and the second lateral side 22.

A first support 40 is coupled to the enclosure 12 and the first support 40 extends between the first lateral side 20 and the second lateral side 22. The first support 40 is positioned closer to the front side 16 than the back side 18. A second support 42 is slidably attached to the enclosure 12 and the second support 42 extends between the first lateral side 20 and the second lateral side 22. The second support 42 is slidable between a middle 44 of the enclosure 12 and the back side 18 and each of the first support 40 and the second support 42 may have a water saw 46 positioned thereon. The water saw 46 may be a tile saw or the like.

A plurality of steps 48 is coupled to the enclosure 12 and the steps 48 extend between the first lateral side 20 and the second lateral side 22. The steps 48 are spaced apart from each other and distributed between the front side 16 and the first support 40. Each of the steps 48 may support a user and each of the steps 48 may be textured to provide a non-slip support for the user.

A pump 50 is provided that is positioned within the well 36 and the pump 50 may be fluidly coupled to the water saw 46. The pump 50 urges the fluid 38 in the well 36 into the water saw 46 such that the pump 50 re-circulates overspray from the water saw 46. The pump 50 may be a fluid pump of any conventional design. A power supply 52 is attached to the outer surface 26 of the peripheral wall 14 and the pump 50 is electrically coupled to the power supply 52. The power supply 52 includes a cord 54 extending outwardly from the power supply 52 and the cord 54 may be electrically coupled to a power source 56. The power source 56 may be an electrical outlet or the like.

A plurality of sleeves 58 is provided and each of the sleeves 58 has an open top end 60. Each of the sleeves 58 is attached to the inner surface 24 of the peripheral wall 14 and the sleeves 58 are spaced apart from each other and distributed between the front side 16 and the back side 18. The sleeves 58 comprise a first set of sleeves 62 positioned on the first lateral side 20 and a second set of sleeves 64 positioned on the second lateral side 22.

A first fastener 66 is coupled to the enclosure 12 and the first fastener 66 is positioned on the inner surface 24 of the peripheral wall 14. The first fastener 66 is positioned adjacent to the top edge 30 of the peripheral wall 14 and the first fastener 66 is coextensive with the first lateral side 20, the back side 18 and the second lateral side 22. The first fastener 66 is comprised of a magnetic material.

A plurality of wheels 68 is provided. Each of the wheels 68 is rotatably attached to the bottom wall 28 and each of the wheels 68 is positioned proximate an associated one of four corners 70 of the bottom wall 28. Each of the wheels 68 abuts the support surface 34 thereby facilitating the enclosure 12 to be rolled along the support surface 34. A frame 72 may be movably attached between each of the wheels 68 and the frame 72 may include a front arm 74 that is coextensive with the front side 16 of the enclosure 12. A collar 76 may be attached to the front arm 74 and the collar 76 may be centrally positioned on the front arm 74.

A handle 78 is provided that has a first rod 80 that is coupled to and oriented transversely to a second rod 82. The second rod 82 may be selectively attached to the collar 76 such that manipulation of the handle 78 urges the frame 72 between an extending position and a retracting position. The frame 72 selectively extends and retracts the wheels 68 relative to the enclosure 12 to lift the enclosure 12 upwardly from the support surface 34 and lower the enclosure 12 downwardly to abut the support surface 34. The handle 78 may extend and retract the wheels 68 through any conventional mechanical means.

A tent 84 is provided that is removably positioned on the enclosure 12 and the tent 84 contains overspray from the water saw 46 within the enclosure 12. The tent 84 includes a plurality of poles 86 and each of the poles 86 is removably inserted into the open top end 60 of an associated pair of the sleeves 58. Each of the poles 86 defines an arch extending upwardly from the enclosure 12 and the poles 86 are spaced apart from each other and distributed between the front side 16 and the back side 18. The poles 86 may be tent poles of any conventional design.

A membrane 88 is provided that has an inside surface 90, an outside surface 92 and a lowermost edge 94 extending between the inside surface 90 and the outside surface 92. The membrane 88 is positionable over the poles 86 when the poles 86 are positioned into the sleeves 58 having the inside surface 90 abutting the poles 86 and having the lowermost edge 94 being coextensive with the top edge 30 of the peripheral wall 14. The membrane 88 defines a workspace 96 that completely surrounds the water saw 46 when the water saw 46 is positioned on the first 40 and second 42 supports.

The membrane 88 has a front side 98 and the front side 98 has a cut 100 extending through the inside surface 90 and the outside surface 92 to allow the user to enter the workspace 96. The cut 100 is closable to form a fluid impermeable seal and the membrane 88 is comprised of a fluid impermeable material. Additionally, the membrane 88 may be comprised of a translucent material. A second fastener 102 is attached to the outside surface 92 of the membrane 88 and the second fastener 102 is coextensive with the lowermost edge 94. The second fastener 102 magnetically engages the first fastener 66 when the membrane 88 is positioned over the poles 86. Moreover, the first fastener 66 and the second fastener 102 form a fluid impermeable seal. The membrane 88 has a first lateral side 104 and the first lateral side 104 has an opening 106 extending therethrough. A gasket 108 is positioned within the opening 106 and a power cord 110 of the water saw 46 is extendable through the gasket 108. The gasket 108 forms a fluid impermeable seal with respect to the power cord 110 of the water saw 46.

A cover 112 is provided that has an upper wall 114 and an exterior wall 116 coupled to and extending downwardly from an outer edge 118 of the upper wall 114. The exterior wall 116 has first lateral side 120, a second lateral side 122, a front side 124, an outermost surface 126, an innermost surface 128 and a bottom edge 130. The cover 112 is positionable on the enclosure 12 having the bottom edge 130 abutting the top edge 30 of the enclosure 12. The front side 124 of the cover 112 extends beyond each of the first lateral side 120 of the cover 112 and the second lateral side 122 of the cover 112. The front side 124 of the cover 112 abuts the front side 16 of the enclosure 12 when the cover 112 is positioned on the enclosure 12.

A handle 121 is provided that has a pair of rods 123 attached to a grip 125 and the rods 123 are spaced apart from each other. Each of the rods 123 is slidably attached to the front side 124 of the cover 112. The handle 121 is positionable in a stored position having the grip 125 abutting the front side 124. The handle 121 is positionable in an extended position having the grip 125 being spaced from the front side 124. Thus, the grip 125 may be gripped to transport the enclosure 12.

A plurality of latches 132 is provided and each of the latches 132 is attached to the outer surface 26 of the enclosure 12. At least one of the latches 132 is positioned on the first lateral side 20 of the enclosure 12 and at least one of the latches 132 is positioned on the second lateral side 22 of the enclosure 12. A plurality of hooks 134 is provided and each of the hooks 134 is attached to the outermost surface 126 of the cover 112. At least one of the hooks 134 is positioned on the first lateral side 120 of the cover 112 and at least one of the hooks 134 is positioned on the second lateral side 122 of the cover 112. Each of the hooks 134 engages a selected one of the latches 132 to removably retain the cover 132 on the enclosure 12.

A pair of straps 136 is provided and each of the straps 136 is attached to the innermost surface 128 of the cover 112. Each of the straps 136 extends between the first lateral side 120 of the cover 112 and the second lateral side 122 of the cover 112. Each of the straps 136 retains the tent 84 in the cover 112 when the cover 112 is positioned on the enclosure 12.

In use, the enclosure 12 is positioned proximate a work area. The work area may be inside of a structure that is under construction or the like. The cover 112 is removed from the enclosure 12 and the water saw 46 is positioned on the first 40 and second 42 supports. The poles 86 are positioned within the sleeves 58 and the membrane 88 is positioned over the poles 86. The water saw 46 is utilized in the convention of water saws 46. The enclosure 12 allows the water saw 46 to be utilized within the structure without exposing the structure to overspray from the water saw 46. Additionally, the enclosure 12, the tent 84 and the pump 50 allow the water saw 46 to be utilized without having to continually service the water saw 46 with the fluid 38. The work area may be located outside of the structure and the membrane 88 shelters the user from the elements while the water saw 46 is utilized. The poles 86 and the membrane 88 are stored within the cover 112 when the enclosure 12 is not being utilized.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An enclosed water saw assembly configured to prevent overspray from a water saw from being released into a surrounding area with respect to the water saw, said assembly comprising:
an enclosure having a bottom wall, said bottom wall being structured to define a well extending downwardly therefrom, said bottom wall sloping downwardly toward said well wherein said bottom wall is configured to direct a fluid into said well;
a first support coupled to said enclosure;
a second support being slidably attached to said enclosure, each of said first support and said second support being configured to have a water saw positioned thereon;
a pump positioned within said well, said pump being configured to be fluidly coupled to the water saw, said pump being configured to urge the fluid in said well into the water saw such that said pump re-circulates overspray from the water saw;
a tent being removably positioned on said enclosure, said tent being configured to contain overspray from the water saw within said enclosure; and
a cover being positionable on said enclosure.

2. The assembly according to claim 1, wherein said enclosure includes a peripheral wall, said peripheral wall having a front side, a back side, a first lateral side and a second lateral side, said peripheral wall having an inner surface and an outer surface, said bottom wall being coupled to said inner surface, said bottom wall extending between said front side, said back side, said first lateral side and said second lateral side, said peripheral wall having a top edge and a bottom edge, said bottom wall being positioned between said top edge and said bottom edge, said bottom edge being configured to be positioned on a support surface.

3. The assembly according to claim 2, wherein said well being positioned adjacent to said first lateral side, said well being centrally positioned on said first lateral side, said bottom wall sloping downwardly from said front side, said back side and second lateral side toward said well, said front side having a height being less than a height of each of said back side, said first lateral side and said second lateral side.

4. The assembly according to claim 2, wherein said first support extends between said first lateral side and said second lateral side, said first support being positioned closer to said front side than said back side, said second support extending between said first lateral side and said second lateral side, said second support being slidable between a middle of said enclosure and said back side.

5. The assembly according to claim 1, further comprising:
said enclosure having a first lateral side, a second lateral side and a front side;
a first support; and
a plurality of steps coupled to said enclosure, said steps extending between said first lateral side and said second lateral side, said steps being spaced apart from each other and distributed between said front side and said first support, each of said steps being configured to support a user.

6. The assembly according to claim 5, further comprising:
a peripheral wall having an inner surface; and
a plurality of sleeves, each of said sleeves having an open top end, each of said sleeves being attached to said inner surface of said peripheral wall, said sleeves being spaced apart from each other and distributed between said front side and said back side, said sleeves comprising a first set of sleeves being positioned on said first lateral side and a second set of sleeves being positioned on said second lateral side.

7. The assembly according to claim 6, further comprising:
said peripheral wall having a top edge; and
a first fastener coupled to said enclosure, said first fastener being positioned on said inner surface of said peripheral wall, said first fastener being positioned adjacent to said top edge of said peripheral wall, said first fastener being coextensive with said first lateral side, said back side and said second lateral side, said first fastener being comprised of a magnetic material.

8. The assembly according to claim 1, further comprising a plurality of wheels, each of said wheels being rotatably attached to said bottom wall, each of said wheels being positioned proximate an associated one of four corners of said bottom wall, each of said wheels abutting the support surface thereby facilitating said enclosure to be rolled along the support surface.

9. The assembly according to claim 8, further comprising a handle having a first rod being coupled to and oriented transversely to a second rod, second rod being operationally coupled to said wheels such that manipulation of said handle selectively extends and retracts said wheels relative to said enclosure to lift said enclosure upwardly from the support surface and lower said enclosure downwardly to abut the support surface.

10. The assembly according to claim 9, wherein:
said enclosure has a front side and a back side;
said enclosure includes a plurality of sleeves, each of said sleeves having an open top end; and
said tent comprises a plurality of poles, each of said poles being removably inserted into said open top end of an associated pair of said sleeves such that each of said poles defines an arch extending upwardly from said enclosure, said poles being spaced apart from each other and distributed between said front side and said back side.

11. The assembly according to claim 10, further comprising:
a peripheral wall having a top edge; and
a membrane having an inside surface, an outside surface and a lowermost edge extending between said inside surface and said outside surface, said membrane being positionable over said poles when said poles are positioned into said sleeves having said inside surface abutting said poles and having said lowermost edge being coextensive with said top edge of said peripheral wall, said membrane being configured to define a workspace that completely surrounds the water saw when the water saw is positioned on said supports.

12. The assembly according to claim 11, wherein said membrane has a front side, said front side having a cut extending through said inside surface and said outside surface wherein said front side is configured to allow a user to enter the workspace, said cut being closable to form a fluid impermeable seal, said membrane being comprised of a fluid impermeable material.

13. The assembly according to claim 12, further comprising:
a first fastener; and
a second fastener attached to said outside surface of said membrane, said second fastener being coextensive with said lowermost edge, said second fastener magnetically engaging said first fastener when said membrane is positioned over said poles wherein said first fastener and said second fastener are configured to form a fluid impermeable seal.

14. The assembly according to claim 1, wherein said cover has an upper wall and an exterior wall coupled to and extending downwardly from an outer edge of said upper wall, said exterior wall having first lateral side, a second lateral side, an outermost surface, an innermost surface and a bottom edge, said cover having said bottom edge abutting a top edge of said enclosure.

15. The assembly according to claim 14, further comprising a plurality of latches, each of said latches being attached to an outer surface of said enclosure, at least one of said latches being positioned on a first lateral side of said enclosure, at least one of said latches being positioned on a second lateral side of said enclosure.

16. The assembly according to claim 15, further comprising a plurality of hooks, each of said hooks being attached to said outermost surface of said cover, at least one of said hooks being positioned on said first lateral side of said cover, at least one of said hooks being positioned on said second lateral side of said cover, each of said hooks engaging a selected one said latches wherein said cover is removably retained on said enclosure.

17. The assembly according to claim 16, further comprising a pair of straps, each of said straps being attached to said innermost surface, each of said straps extending between said first lateral side of said cover and said second lateral side of said cover, each of said straps retaining said tent in said cover when said cover is positioned on said enclosure.

18. An enclosed water saw assembly configured to prevent overspray from a water saw from being released into a surrounding area with respect to the water saw, said assembly comprising:
an enclosure having a peripheral wall, said peripheral wall having a front side, a back side, a first lateral side and a second lateral side, said peripheral wall having an inner surface and an outer surface, said enclosure including a bottom wall coupled to said inner surface, said bottom wall extending between said front side, said back side, said first lateral side and said second lateral side, said peripheral wall having a top edge and a bottom edge, said bottom wall being positioned between said top edge and said bottom edge, said bottom edge being configured to be positioned on a support surface, said bottom wall being structured to define a well extending downwardly therefrom, said well being positioned adjacent to said first lateral side, said well being centrally positioned on said first lateral side, said bottom wall sloping downwardly from said front side, said back side and second lateral side toward said well wherein said bottom wall is configured to direct a fluid into said well, said front side having a height being less than a height of each of said back side, said first lateral side and said second lateral side;
a first support coupled to said enclosure, said first support extending between said first lateral side and said second lateral side, said first support being positioned closer to said front side than said back side;
a second support being slidably attached to said enclosure, said second support extending between said first lateral side and said second lateral side, said second support being slidable between a middle of said enclosure and said back side, each of said first support and said second support being configured to have a water saw positioned thereon;
a plurality of steps coupled to said enclosure, said steps extending between said first lateral side and said second lateral side, said steps being spaced apart from each other and distributed between said front side and said first support, each of said steps being configured to support a user;
a pump positioned within said well, said pump being configured to be fluidly coupled to the water saw, said pump being configured to urge the fluid in said well into the water saw such that said pump re-circulates overspray from the water saw;
a plurality of sleeves, each of said sleeves having an open top end, each of said sleeves being attached to said inner surface of said peripheral wall, said sleeves being spaced apart from each other and distributed between said front side and said back side, said sleeves comprising a first set of sleeves being positioned on said first lateral side and a second set of sleeves being positioned on said second lateral side;
a first fastener coupled to said enclosure, said first fastener being positioned on said inner surface of said peripheral wall, said first fastener being positioned adjacent to said top edge of said peripheral wall, said first fastener being coextensive with said first lateral side, said back side and said second lateral side, said first fastener being comprised of a magnetic material;
a plurality of wheels, each of said wheels being rotatably attached to said bottom wall, each of said wheels being positioned proximate an associated one of four corners of said bottom wall, each of said wheels abutting the support surface thereby facilitating said enclosure to be rolled along the support surface;
a handle having a first rod being coupled to and oriented transversely to a second rod, second rod being operationally coupled to said wheels such that manipulation of said handle selectively extends and retracts said wheels relative to said enclosure to lift said enclosure upwardly from the support surface and lower said enclosure downwardly to abut the support surface;
a tent being removably positioned on said enclosure, said tent being configured to contain overspray from the water saw within said enclosure, said tent comprising
a plurality of poles, each of said poles being removably inserted into said open top end of an associated pair of said sleeves such that each of said poles defines an arch extending upwardly from said enclosure, said poles being spaced apart from each other and distributed between said front side and said back side,
a membrane having an inside surface, an outside surface and a lowermost edge extending between said inside surface and said outside surface, said membrane being positionable over said poles when said poles are positioned into said sleeves having said inside surface abutting said poles and having said lowermost edge being coextensive with said top edge of said peripheral wall, said membrane being configured to define a workspace that completely surrounds the water saw when the water saw is positioned on said supports, said membrane having a front side, said front side having a cut extending through said inside surface and said outside surface wherein said front side is configured to allow a user to enter the workspace, said cut being closable to form a fluid impermeable seal, said membrane being comprised of a fluid impermeable material, and
a second fastener attached to said outside surface of said membrane, said second fastener being coextensive with said lowermost edge, said second fastener magnetically engaging said first fastener when said membrane is positioned over said poles wherein said first fastener and said second fastener are configured to form a fluid impermeable seal, and
a cover having an upper wall and an exterior wall coupled to and extending downwardly from an outer edge of said upper wall, said exterior wall having first lateral side, a second lateral side, an outermost surface, an innermost surface and a bottom edge, said cover being positionable on said enclosure having said bottom edge abutting said top edge of said enclosure;
a plurality of latches, each of said latches being attached to said outer surface of said enclosure, at least one of said latches being positioned on said first lateral side of said enclosure, at least one of said latches being positioned on said second lateral side of said enclosure;
a plurality of hooks, each of said hooks being attached to said outermost surface of said cover, at least one of said hooks being positioned on said first lateral side of said cover, at least one of said hooks being positioned on said second lateral side of said cover, each of said hooks engaging a selected one said latches wherein said cover is removably retained on said enclosure; and
a pair of straps, each of said straps being attached to said innermost surface, each of said straps extending between said first lateral side of said cover and said second lateral side of said cover, each of said straps retaining said tent in said cover when said cover is positioned on said enclosure.
